(19) United States
(12) Patent Application Publication
(10) Pub. No.: US 2009/0018823 A1
(43) Pub. Date: Jan. 15, 2009

(54) Speech coding

(75) Inventors: Herve Taddei, Munich (DE); Mickael de Meuleneire, Munich (DE)

Correspondence Address: STAAS & HALSEY LLP, SUITE 700, 1201 NEW YORK AVENUE, N.W., WASHINGTON, DC, 20005, US

(73) Assignee: Nokia Siemens Networks OY, Espoo (FI)

(21) Appl. No.: 12/215,412

(22) Filed: Jun. 27, 2008

(30) Foreign Application Priority Data
Jun. 27, 2006 (EP) EP07012614

(51) Int. Cl. G10L 19/00; G10L 21/00

(52) U.S. Cl. 704/201; 704/219; 704/500; 704/E19.039; 704/E19.01

(57) ABSTRACT

A method of encoding a speech signal for transmission in a communications network involves transforming the signal into a sequence of frames, each frame including a plurality of coefficients; dividing the frame into a set of sub-bands each containing a sub-set of the plurality of coefficients; applying an optimization function to calculate respective test values corresponding to respective candidate sets of pulses representing a coded form of at least some of the coefficients; and selecting a set of pulses having a test value which meets a selectability criterion. If the optimisation function is an error function, the selectability criterion is minimization of the function. If the optimization function is an iterative function, the selectability criterion is selecting an iteration in which a certain condition is reached.

### CROSS REFERENCE TO RELATED APPLICATIONS

This application is based on and hereby claims priority to European Application No. EP07012614 filed on Jun. 27, 2007, the contents of which are hereby incorporated by reference.

### BACKGROUND OF THE INVENTION

This invention relates to an audio coding method and an encoder and decoder for carrying out the same. A mobile terminal or a network element may incorporate an audio encoder and/or decoder for coding and/or decoding an audio signal. The method is particularly applicable to speech coding.

The goal of audio encoding is to reduce the amount of data which is to be transmitted over a link or a channel or which is to be stored (for example on a memory card or in an MP3 player). If the data is being transmitted it may travel over a wireless connection (for example a channel in a mobile telephony system, such as the GSM system) or on a path through several routers in the Internet.

Audio encoding typically involves a plurality of techniques in which the information present in an audio signal can be represented in a more reduced, or compressed, manner. These include:

identifying redundant elements in the signal and encoding them in an efficient manner, for example by encoding repetitive parts of speech in relatively few parameters; using codebooks so fewer bits can be transmitted identifying a vector than are contained in the vector itself; and
only transmitting data that is relevant to the human auditory system (for example, in narrowband speech coding, only information in the frequency band 300 Hz to 3400 Hz is transmitted but this still provides an intelligible reconstructed output signal).

Decoding tends to be computationally simpler than encoding and generally involves a reversal of the steps involved in the encoding process. It is typically the case that once an audio signal has been encoded and then subsequently decoded some information is lost although encoding/decoding is configured so that any consequent loss of quality does not adversely affect the intelligibility of the reconstructed output signal.

An audio coder usually works on a frame-by-frame basis. A digital input signal is divided into groups of samples of equal length. For each frame, a set of parameters are computed based on samples within a frame. These parameters are quantized and transmitted. At the decoder side, the samples are estimated from the transmitted values of the parameters.

Transmission of speech signals has a privileged place in communication systems, like fixed-line and mobile telephony, or VolP. Although an 8 kHz sampling frequency might be sufficient for intelligibility of reconstructed speech, there may be problems in the reproduction of sounds whose energy is concentrated above 3-4 kHz, like fricatives. This can be dealt with by using a higher sampling frequency. Candidates for coding of speech signals must produce a high quality synthesised speech at low complexity, at low bit-rates, and with a low delay. These constraints usually lead to lossy coding being chosen. The coders applicable to speech signals are traditionally gathered in three classes:

1) Waveform-approximating coders—the speech signal is digitised and each sample is coded by a constant number of bits (G.711 or PCM [ITU-T, 1988a], Pulse Code Modulation). As a result, the reconstructed signal converges towards the original signal with decreasing quantisation error when increasing the bit-rate. Thus, they are also suitable for non-speech signals. The number of bits needed for quantisation can be reduced when the difference between the sample and its linear prediction from a few previous samples is coded (G.721 or ADPCM, Adaptive Differential Pulse Code Modulation). They provide high speech quality at bit-rate greater than 16 kbit/s. Below this limit, the quality degrades rapidly.
2) Parametric coders—after sampling of the speech signal, the digital signal is divided into blocks. From each block of samples, parameters corresponding to a speech synthesis model are computed and then quantized. The vocal tract is represented as a time-varying filter and is excited with either a white noise source, for unvoiced speech segments, or a train of pulses separated by the pitch period for voiced speech. For instance in Linear Predictive Coding (LPC) vocoders, the filter is derived from a linear prediction. Therefore, the information which must be sent to the decoder is the filter coefficients, a voiced/unvoiced flag, the necessary variance of the excitation signal, and the pitch period for voiced speech. The block size is 10-30 ms, corresponding approximately to the length of the speech stationarity. Although the decoded speech signal is still intelligible, the quality is far from the one obtained with waveform-approximating coders, and the reconstructed signal sounds unnatural. Such codecs are used in military applications where the very low bit-rates (usually lower than 4 kbit/s) are preferred to a natural-sounding speech, permitting heavy data protection and encryption.
3) Hybrid coders—these are a trade-off between the two previous categories. They provide a good speech quality while decreasing the bit-rate below 16 kbit/s. Among the hybrid codecs, the most commonly used are Analysis-by-Synthesis coders using the same linear prediction as LPC vocoders. Instead of using a two-state model (voiced-unvoiced) like in parametric coding, the residual excitation is computed independently on the type of the speech segment. Hence the quality is better. The bit-rate of such coders is between 4 kbit/s and 16 kbit/s. Cellular telephony, motivated by saving of spectral resources, or packet transmission over an X-network, are common applications of hybrids codecs. They provide a good speech quality while keeping the necessary bit-rate below 16 kbit/s (in order to, for example, allocate more bits to channel coding).

While codecs from the second and third categories perform quite badly on signals other than speech, because they rely on a speech-production model, the waveform codecs can be applied equally to every kind of audio signals. It is also usual to distinguish between time-domain codecs using for instance linear prediction and frequency-domain codecs based on short-term spectral analysis. Time-domain codec based on linear prediction are suitable for speech with bit-rates less than 2 bits/sample. Conversely, frequency-domain codecs give good results for music with bit-rates from 2 bits/sample.

Originally, codecs were developed which operated at a constant bit-rate. The same number of bits is transmitted for each frame. More recently, codecs have been developed to work at several bit-rates. The number of transmitted parameters and their quantisation differs from one bit-rate to the other. In such cases, the encoder and decoder must negotiate the bit-rate to use during communication. If for some reason it has been necessary to increase or decrease the bit-rate, the encoder and decoder must re-negotiate a new bit-rate.

When transmitting data across networks, particularly across router based networks or networks having wireless links, then unless there is a mechanism to recover lost or corrupted data, the decoder might be unable to reconstruct frame samples, causing impairments in the reconstructed signal. The concept of embedded (or sometimes called scalable) coding is intended to alleviate such problems.

In embedded or scalable coding, the bit-stream is organised into layers. These comprise a core layer which is a group of bits within a frame necessary to reconstruct the signal at a minimum quality and/or bandwidth and an enhancement layer (or enhancement layers) (E.L) which are additional bits which aim to improve the synthesis and/or increase the bandwidth. If some core layer bits are missing or corrupted (and not recoverable by any available technique), synthesis is not possible. Such a bit-stream structure is called embedded and is the result of scalable algorithms.

Scalable coding is particularly suitable for delivering content. To reduce network congestion or to increase the number of users over a backbone, some entities in the network may discard the higher layers. Unequal error protection can very easily be implemented with a simple scheme where, for example, the core layer is better protected than the other layers. Enhancement layers can also be encrypted. Only premium users will have access to the highest quality. Also, with a coder offering a range of coding from lossy to lossless, the core layer may provide a preview of the content which is being transmitted.

### SUMMARY

A method of encoding an audio signal, as proposed by the inventors, involves:

a) transforming the signal into a sequence of frames, each frame comprising a plurality of coefficients;
b) applying an optimisation function to calculate respective test values corresponding to respective candidate sets of pulses representing a coded form of at least some of the coefficients;
c) selecting a set of pulses having a test value which meets a selectability criterion.

The inventors propose a terminal capable of encoding an audio signal having:

a) a transformer which is capable of transforming the signal into a sequence of frames, each frame comprising a plurality of coefficients;
b) an optimiser which is capable of applying an optimisation function to calculate respective test values corresponding to respective candidate sets of pulses representing a coded form of at least some of the coefficients;
c) a selector which is capable of selecting a set of pulses having a test value which meets a selectability criterion.

Preferably, the terminal is a mobile handset. It may be a mobile telephone. Alternatively, it may be an audio recording and/or playback device.

The inventors also propose a network element capable of encoding an audio signal, the element having:

a) a transformer which is capable of transforming the signal into a sequence of frames, each frame comprising a plurality of coefficients;
b) an optimiser which is capable of applying an optimisation function to calculate respective test values corresponding to respective candidate sets of pulses representing a coded form of at least some of the coefficients;
c) a selector which is capable of selecting a set of pulses having a test value which meets a selectability criterion.

The inventors further propose a system capable of encoding an audio signal, the system having:

a) a transformer which is capable of transforming the signal into a sequence of frames, each frame comprising a plurality of coefficients;
b) an optimiser which is capable of applying an optimisation function to calculate respective test values corresponding to respective candidate sets of pulses representing a coded form of at least some of the coefficients;
c) a selector which is capable of selecting a set of pulses having a test value which meets a selectability criterion.

Still further, the inventors propose a computer executable code capable of encoding an audio signal, the code having:

a) executable code which is capable of transforming the signal into a sequence of frames, each frame comprising a plurality of coefficients;
b) executable code which is capable of applying an optimisation function to calculate respective test values corresponding to respective candidate sets of pulses representing a coded form of at least some of the coefficients;
c) executable code which is capable of selecting a set of pulses having a test value which meets a selectability criterion.

A chipset capable of encoding an audio signal might include:

a) a transformer which is capable of transforming the signal into a sequence of frames, each frame comprising a plurality of coefficients;
b) an optimiser which is capable of applying an optimisation function to calculate respective test values corresponding to respective candidate sets of pulses representing a coded form of at least some of the coefficients;
c) a selector which is capable of selecting a set of pulses having a test value which meets a selectability criterion.

According to another embodiment, there is provided a method of encoding a frame comprising a plurality of coefficients in which:

a) an error function, representing the sum of the differences between original coefficients and coded coefficients, is applied;
b) respective error values are calculated corresponding to respective candidate sets of pulses;
c) a set of pulses is selected which provides a lowest error value; and
d) the selected set of pulses is used to calculate an amplitude value.

Preferably, the amplitude value represents the average of the absolute value of the selected coefficients.

Preferably, the method does not operate on the whole of a frame but instead is applied to bands, or sub-sets, of the coefficients of the frame. This can help reduce computational load in a speech encoder. All of the coefficients of the frame may be processed in a plurality of operations, one for each band or sub-set.

Preferably, the audio signal comprises speech.

In one embodiment, the audio signal is transformed using a frequency transform such as wavelet packet transform. In other embodiments, other types of transform can be used, for example, Modified Discrete Cosine Transform (MDCT), Lapped Orthogonal transform functions, or Fast Fourier Transform (FFT).

Preferably, optimisation involves the selection of a set of pulses to represent some or all of the coefficients on the basis that the pulses are a sufficiently close match to the coefficients. In some case all of the coefficients will be represented by a pulse. In other cases, only some of the coefficients will be represented by a pulse. A lack of one-to-one correspondence between coefficients and pulses may be caused by the nature of the coefficients themselves, that is a particular set of coefficients may be represented by fewer pulses resulting in a sufficiently close match between the coefficients and the pulses thus allowing some coefficients to remain unrepresented. If coefficients are not represented by a pulse, they may be assigned a zero value.

Pulses may be identified by comparing the original coefficients with a threshold. The threshold may be based on an amplitude value.

An error function, representing the sum of the differences between original coefficients and coded coefficients, may be applied to various combinations of coefficients in order to identify a set of coefficients which provides a lowest error value. An original coefficient may be compared with a coded coefficient in the form of a pulse multiplied by an amplitude value.

Preferably, the selected set of pulses is used to calculate an amplitude value for the frame. The calculation may also be based on the coefficients. The selected set of pulses may be amongst a plurality of candidate sets of pulses which are used to calculate respective amplitude values for the frame or sub-set of the frame. The amplitude value may be based on an average of the absolute values of the original coefficients. There may only be a single amplitude value calculated for the whole of the frame or part of the frame.

Preferably, the coefficients are coded into the selected set of pulses and the amplitude value and the coefficients may be reconstructed by multiplying the coefficients by the amplitude value.

In one embodiment, the optimisation function is an error function. In this case, the selectability criterion may be to identify the minimum error result produced by the error function for a plurality of candidate sets of pulses.

In another embodiment, an iterative process is used to produce a succession of test values and one of these is identified as the test value which indicates the selected set of pulses when the iterative process is perceived to have produced a less optimum test value than the previous test value. In a variation of this embodiment, the iterative process produces test values for all of the possible combinations of candidate sets of pulses (or a sub-set of such combinations) and the selected set of pulses is selected which results in the most optimum test value. Although it is preferred that there is a single criterion, in other embodiments, there may be a set of criteria rather than a single criterion.

Preferably, the iterative process carries out an examination of the coefficients to identify which are to be encoded as pulses. This examination may be done coefficient-by-coefficient. Pulses may be so identified up to the point at which the iterative process is perceived to have produced a less optimum test value than the previous test value.

Preferably, the coefficients are examined in order of absolute value. The examination may proceed from the largest absolute value to the smallest, or in a preferred embodiment until the iterative process is perceived to have produced a less optimum test value than the previous test value.

Preferably, a value dₖ is calculated based on the biggest coefficient (in the sense of the absolute value) and then further dₖ contributions of subsequent coefficients are successively added to produce more refined iterations of dₖ. In one embodiment, dₖ represents an energy measure related to a difference between the correlation between original coefficients and corresponding candidate sets of pulses. It may also represent the energy of the candidate sets.

Preferably, test values are calculated by successively adding to the calculation of the test value, coefficient-by-coefficient, a contribution from at least some of the coefficients. In another embodiment, test values are calculated separately from respective sets of coefficients. A subsequent set of coefficients may include one additional coefficient compared to a previous set of coefficients.

Rather than calculating test values for only some of the coefficients, a contribution may be provided by each of the coefficients until a contribution from all coefficients has been provided.

A set of pulses may be selected which corresponds to a set of coefficients which provides the most optimum test value. This may be the test value having the greatest value, whether absolute or not.

Preferably, an amplitude value is calculated based on the pulses extracted and the corresponding coefficients. The amplitude value may represent an average of the original coefficients for which corresponding pulses are to be transmitted.

Preferably, a signal is encoded for transmission over a wireless link in a mobile communications network. It may be for transmission through a router switched network. It may be encoded for storage on a storage medium.

The proposed method can be used to provide a ready way to identify which coefficients are to be coded into their positions, signs, and amplitude values.

The proposed method can be described as algebraic quantization using a pulse approach of speech/audio transform coefficients.

In summary, one way of expressing the proposed method is:

For each frame or part of a frame, the method determines which pulses have to be transmitted by minimizing a distance criterion. A minimization operation is carried out to work out a best fit.
An amplitude value is calculated that best represents each of the selected set of pulses for an original set of coefficients. This amplitude value is also transmitted.
For each frame or part of a frame, the decoder reconstructs the transmitted coefficients from the signs of the pulses and the transmitted amplitude value.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an encoder proposed by the inventors;

FIG. 2 shows a decoder proposed by the inventors;

FIG. 3 shows detail of the encoder of FIG. 2 according to one implementation;

FIG. 4 shows detail of the encoder of FIG. 2 according to another implementation;

FIG. 5 shows detail of the encoder of FIG. 2 according to yet another implementation;

FIG. 6 shows detail of the encoded of FIG. 2 according to yet a still further embodiment;

FIG. 7 shows the result of applying the proposed method to an original set of coefficients; and

FIG. 8 shows an audio coding chain.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

In conversion of speech into a digital form prior to encoding, variations in sound pressure level produced by a person speaking are converted into an analogue signal by a transducer, typically a microphone. After low pass-filtering, the analogue signal is converted by an Analogue-to-Digital Converter (ADC), comprising a sampling unit and a quantizer, into a digital signal. The resulting digital signal is encoded into a bit-stream which is provided to an encoder. An audio coding chain capable of carrying out these stages of conversion is shown in the upper part of FIG. 8.

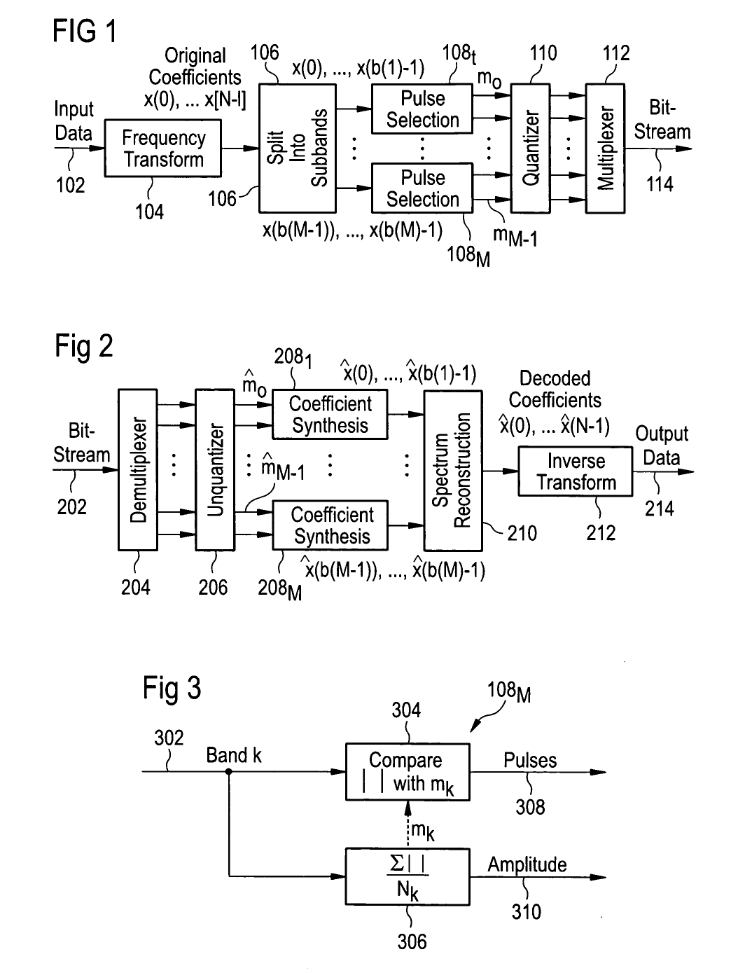

FIGS. 1 and 2 describe an encoder and a decoder respectively, for example those present in FIG. 8. These are particularly adapted to encode and decode a speech signal in digital form and are intended to be used in transmission systems for transmitting speech, whether in the form of mobile communications systems or fixed networks based on routers or other interconnection. In order to allow for duplex communication, the encoder and decoder can be combined into a codec. The term codec refers to a speech encoder/decoder pair. In this description, the term “speech encoder” is used to denote the encoding functions of the speech codec and the term “speech decoder” is used to denote the decoding functions of the speech codec. It should be appreciated that a general speech codec may be implemented as a single functional unit, or as separate elements that implement the encoding and decoding operations. The encoder and decoder, whether in the form of a codec or otherwise, are adapted to be incorporated into mobile handsets, other telecommunications terminals, and in network elements (such as a gateway, or a media gateway), for example to allow for decoding of a speech signal which is being transmitted to another telecommunication system which might not have the necessary decoding capability and also of course to encode a speech signal received from such a telecommunication system.

FIG. 1 shows a proposed encoder 100. The encoder 100 comprises an input 102 for receiving input data, a transform block 104, a splitting block 106, a series of pulse selection blocks 108₁ to 108_{M} for selecting pulses within different bands, a quantizer 110, a multiplexer 112, and an output 114 for outputting encoded data in the form of a bit-stream.

In operation, input data in the form of a speech signal in the time domain is input into the encoder 100 via the input 102. The input data is transformed by the transform block 104 into a sequence of frames, each containing a set of original output coefficients x(0), . . . , x(n−1).

In this embodiment the transform block 104 is implemented as a wavelet packet transform (working in conjunction with an inverse wavelet packet transform in a corresponding decoder). However, any suitable alternative transform function may be used instead, for example Fast Fourier Transform (FFT), Modified Discrete Cosine Transform (MDCT), or Lapped Orthogonal transform functions.

The representation which is described by the output coefficients of the transform is transmitted by the encoder to the decoder with a finite number of bits. The mapping of the coefficients into a bit sequence of finite length (or bit-stream) is called quantization.

Each frame contains N coefficients designated as x(0), x(1), . . . , x(N−2), x(N−1) which are to be quantized. The frame is divided into M groups called sub-bands by the splitting block 106, so that a sub-band comprises Nₖ coefficients, and

$${\sum }_{k = 0}^{M - 1} {N}_{k} = N .$$

The indices of the first coefficient in each band are designated as b(0), b(1), . . . , b(M−2), b(M−1) (with the convention b(M)=N) and a first sub-band comprises coefficients x(0), . . . , x(b(1)−1), and an Mth sub-band contains coefficients x(b(M−1)), . . . , x(b(M)−1). Each of the sub-bands is output from the splitting block 106 and received by a respective pulse selection block 108₁ to 108_{M}. A pulse selection block determines the encoding of coefficients from a respective sub-band. The pulse selection block also calculates an amplitude value for the encoded pulses, or to express this in more mathematical terms, the coefficients x(b(k)+j) are converted into mₖc(b(k)+j), jε0, 1, . . . , Nₖ−2, Nₖ−1 where mₖ is an amplitude value and pulses are c(b(k)+j)=0 or ±1. It should be noted that although in much of this description, pulses are described only as +1 or −1, for the purpose of various of the equations herein, pulses (denoted by c) are given a zero value, although they would not conventionally be understood to be pulses in the normal use of the term. Operation of the pulse selection blocks is described in the following. In a typical embodiment, a frame of 160 original coefficients may be broken down into 16 sub-bands of 10 coefficients each.

The amplitude value mₖ is highly related to the energy in a sub-band. The more energy there is, the higher will be the amplitude value.

The selected sets of pulses for each sub-band and respective amplitude value (designated as m₀, . . . , m_{M-1} in FIG. 1) from the pulse selection blocks 108₁ to 108_{M} are quantized by the quantizer 110 into the quantized coefficients (that is they are encoded into bits) which are then multiplexed together by the multiplexer 112.

Although in FIG. 1, a single quantizer is shown, there can be individual quantizers for each of the pulse selection blocks. If a single quantizer is used which is capable of operating on all the pulses and amplitude values together, for example using vector quantization, the quantizer 110 and multiplexer 112 can be merged together into a single block.

For a band k, the quantization process finds a set of Nₖ values:

\hat{x}(b(k)),\hat{x}(b(k)+1), . . . , \hat{x}(b(k+1)−2),\hat{x}(b(k+1)−1)

among a finite number of possibilities. \hat{x}(j) is the quantized version of x(j). The chosen set may be represented by a unique sequence of bits, that is an index, which, on receipt by the decoder, allows it to use the index to refer to a look-up table containing the chosen set to reproduce the set of values. The efficiency of a quantizer depends on its capability to represent a wide range of coefficients with a small noticeable distortion, on its complexity, and on its bit-rate (the number of bits necessary to represent the coefficients).
The term “pulse” refers to representing a series of coefficients in terms of giving them a value of −1, or +1. Accordingly, it contains both information concerning the sign and/or value of the coefficients and where in a sequence of these signs/values that they are to be applied. It should be noted that usually there is encoding of a sub-set of the coefficients of a sub-band rather than all of the coefficients of a frame being encoded.

FIG. 2 shows a proposed decoder 200. The decoder 200 receives encoded data which has been encoded and output by the encoder 100 and then received by the decoder. In a preferred embodiment, transmission occurs over a mobile communications network although other forms of transmission are envisaged, for example in a fixed line network or even within a device where input data are stored (encoded) for later recall (decoding). The decoder 200 comprises an input 202 for a bit-stream, a demultiplexer 204, a dequantizer 206, a series of coefficient synthesis blocks 208₁ to 208_{M}, a spectrum reconstruction block 210, an inverse transform block 212, and an output 214 for outputting decoded data.

In operation, an encoded bit-stream is input into the decoder 200 via the input 202. The input data is demultiplexed by the demultiplexer 204 into a bit-stream representing the various sub-bands together with their respective amplitude values which are then dequantized by the dequantized 206. This is simply an inverse of the operation carried out by the quantizer 110 in FIG. 1. For a particular sub-band, this decodes the demultiplexed bit-stream into sets of pulses designated in FIG. 2 as \hat{m}₀, . . . , \hat{m}_{M-1}. The pulses and amplitude values are then multiplied together in coefficient synthesis blocks 208₁ to 208_{M} to produce decoded (reconstructed) coefficients \hat{x}(0), \hat{x}(1), . . . , \hat{x}(N−2), \hat{x}(N−1) which themselves are then combined in a spectrum reconstruction block 210 to produce a decoded frame. The reconstructed coefficients of the decoded frame then undergo an inverse transformation in the inverse transform block 212 and are put back into a reconstructed speech signal in the time domain. (It should be understood that this may be a signal related to the speech signal rather than the speech signal itself.) The reconstructed speech signal in the time domain is then output by the decoder 200 at the output 214.

The reconstructed speech signal can then be converted into an analogue signal so that it can be played to a listener, for example through a speaker arrangement. A decoder chain for converting encoded speech into an audible reconstruction of the speech is shown in the lower part of FIG. 8.

Various embodiments of the pulse selection block 108_{M} of the encoder of FIG. 2 will now be described. In terms of notation, the form x(b(k)+j) is used to refer to a particular coefficient and the form c(b(k)+j) is used to refer to a particular pulse, (b(k)+j) indicating a pulse or a coefficient at a position j (j=0, 1, 2, . . . , Nₖ−1) within the band k (k=0, 1, 2, . . . , M−1). b(k) indicates the position of the first coefficient of the sub-band k in the frame. The coefficient at the position b(k) in the frame is at the position 0 within the sub-band k.

FIG. 3 shows in more detail a first embodiment of the pulse selection block 108_{M} of the encoder of FIG. 2. The pulse selection block 108_{M} comprises an input 302, which is fed both to a pulse determination block 304 and an amplitude value determination block 306, and a first output 308 which outputs pulses determined by the pulse determination block 304 and a second output 310 which outputs an amplitude value determined by the amplitude value determination block 306 and an output 310.

In operation, the pulse selection block 108_{M} receives a particular band k of a set of coefficients as described above and provides the coefficients to the pulse determination block 304 and the amplitude value determination block 306. By way of example, in one implementation there are fourteen bands, due to a bandwidth limitation of 50-7000 Hz, and ten coefficients per band. The amplitude value determination block 306 calculates an amplitude value mₖ according to the following equation:

$${m}_{k} = \frac{{\sum }_{j = 0}^{{N}_{k} - 1} \vert x ( b ( k ) + j ) \vert}{{N}_{k}} \qquad ( 1 )$$

In this embodiment, the amplitude value mₖ is a simple average of the absolute values of all of the amplitudes of the coefficients in the band. Once the amplitude value mₖ has been calculated, it can be used to determine the pulses which correspond to the coefficients according to the following equation:

$$c ( b ( k ) + j ) = \{ \begin{matrix}1 , if x ( b ( k ) + j ) \geq {m}_{k} \\ 0 , if \vert x ( b ( k ) + j ) \vert < - {m}_{k} \\ - 1 , if x ( b ( k ) + j ) \leq {m}_{k}\end{matrix} \qquad ( 2 )$$

As can be seen, pulses are determined to be 1, or −1 and this determination is carried out by using the amplitude value mₖ as a threshold against which each coefficient is compared.

Once the amplitude value mₖ and the pulses have been determined, they are output via the first and second outputs 308 and 310. After this, the pulse selection block 108_{M} receives a band from the following frame which is to be encoded.

In order to optimize the decoder 200 for this embodiment, it may be necessary to apply an empirically derived factor (a factor of \sqrt{2} has been found to provide suitable results) to the amplitude to adjust its level.

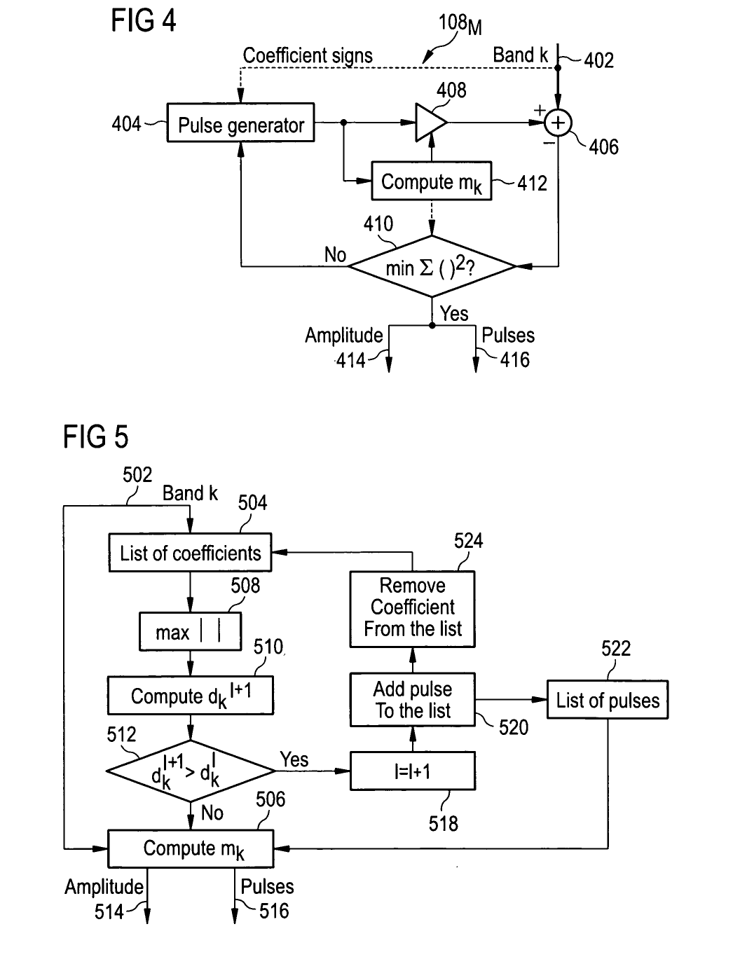

FIG. 4 shows in more detail a second embodiment of the pulse selection block 108_{M} of the encoder of FIG. 2. The pulse selection block 108_{M} comprises an input 402, which is fed both to a pulse generator 404 and a comparator 406, a multiplication block 408, an optimization block 410, an amplitude value calculation block 412, a first output 414, and a second output 416.

Before operation of the pulse selection block 108_{M} of FIG. 4 is described, the background to its operation in mathematical terms will be set out. The amplitude value mₖ, the position and signs of the pulses are given by the minimization of the following optimization criterion:

$${e}_{k} = {\sum }_{j = 0}^{{N}_{k} - 1} {( x ( b ( k ) + j ) - {m}_{k} c ( b ( k ) + j ) )}^{2} \qquad ( 3 )$$

A condition for having a minimum is:

$$\frac{\partial {e}_{k}}{\partial {m}_{k}} = 0$$

In order to determine the minimum, it is necessary for the amplitude value mₖ to be known. This can be expressed as:

$${m}_{k} = \frac{{\sum }_{j = 0}^{{N}_{k} - 1} x ( b ( k ) + j ) c ( b ( k ) + j )}{{\sum }_{j = 0}^{{N}_{k} - 1} {c ( b ( k ) + j )}^{2}} \qquad ( 4 )$$

that is, the absolute values of the selected coefficients added together divided by the number of pulses. (Note that the denominator is the number of pulses to be transmitted.) Calculating eₖ can be achieved by substituting mₖ into the expression above to calculate eₖ, as has been done in the following:

$$\begin{matrix} {e}_{k} = {\sum }_{j = 0}^{{N}_{k} - 1} {( x ( b ( k ) + j ) - \frac{\begin{matrix}{\sum }_{j = 0}^{{N}_{k} - 1} x ( b ( k ) + j ) \\ c ( b ( k ) + j )\end{matrix}}{{\sum }_{j = 0}^{{N}_{k} - 1} {c ( b ( k ) + j )}^{2}} c ( b ( k ) + j ) )}^{2} & ( 5 ) \\ {e}_{k} = {\sum }_{j = 0}^{{N}_{k} - 1} {x ( b ( k ) + j )}^{2} - 2 \frac{{[ \begin{matrix}{\sum }_{j = 0}^{{N}_{k} - 1} x ( b ( k ) + j ) \\ c ( b ( k ) + j )\end{matrix} ]}^{2}}{{\sum }_{j = 0}^{{N}_{k} - 1} {c ( b ( k ) + j )}^{2}} + \frac{{[ \begin{matrix}{\sum }_{j = 0}^{{N}_{k} - 1} x ( b ( k ) + j ) \\ c ( b ( k ) + j )\end{matrix} ]}^{2}}{{\sum }_{j = 0}^{{N}_{k} - 1} {c ( b ( k ) + j )}^{2}} & ( 6 ) \\ {e}_{k} = {\sum }_{j = 0}^{{N}_{k} - 1} {x ( b ( k ) + j )}^{2} - \frac{{[ {\sum }_{j = 0}^{{N}_{k} - 1} x ( b ( k ) + j ) c ( b ( k ) + j ) ]}^{2}}{{\sum }_{j = 0}^{{N}_{k} - 1} {c ( b ( k ) + j )}^{2}} & ( 7 )\end{matrix}$$

This is equivalent to maximizing the expression:

$${d}_{k} = \frac{{[ {\sum }_{j = 0}^{{N}_{k} - 1} x ( b ( k ) + j ) c ( b ( k ) + j ) ]}^{2}}{{\sum }_{j = 0}^{{N}_{k} - 1} {c ( b ( k ) + j )}^{2}} \qquad ( 8 )$$

because the term

$${\sum }_{j = 0}^{{N}_{k} - 1} x ( b ( k ) + j )$$

is independent irrespective of which sets of pulses are being examined.

To simplify the search of pulses, it is reasonable to consider that the pulses should have the same sign as the corresponding coefficients. The number of possibilities to be tested is:

$${\sum }_{j = 0}^{{N}_{k}} {C}_{{N}_{k}}^{j} = {2}^{{N}_{k}} \qquad ( 9 )$$

When the optimal pulses are found, amplitude value mₖ is given by equation 4.

In operation, the pulse selection block 108_{M} receives a particular sub-band k of a set of coefficients as described above and provides the coefficients to both the pulse generator 404 and the comparator 406. The pulse generator 404 performs the operation of a codebook and generates sets of pulses which are candidates to be an encoded version of the coefficients. A first candidate set of pulses is generated which is used to calculate a corresponding amplitude value mₖ according to equation (4) in the amplitude value calculation block 412. The first candidate set of pulses can then be multiplied by the amplitude value mₖ in the multiplication block 408 to produce reconstructed coefficients of the sub-band. They reconstructed coefficients can then by provided to the comparator 406 which compares them against the original coefficients which have been provided to the comparator 406 as described previously and the results of this comparison are then provided to the optimization block 410 to calculate an optimization criterion (or error value) eₖ.

The pulse selection block 108_{M} carries out a search through a plurality of different candidate sets of pulses and selects that set which produces the smallest optimization criterion eₖ (that is produces the smallest error). When the minimum error for one particular set of pulses is detected by the optimization block 410, that set of pulses and a corresponding amplitude value can be output by the first output 414 and the second output 416 respectively.

If the encoder has sufficient processing power, the pulse selection block 108_{M} can search through all of the possible combinations of pulses. The possible combinations are set out as follows:

zero pulse (no coefficient to be transmitted): 1 combination

one pulse (1 coefficient to be transmitted): Nₖ combinations (pulse at position 1, or at position 2, or at position 3, . . . , or at position Nₖ)

two pulses (2 coefficients to be transmitted): Nₖ*(Nₖ−1)/2 combinations (first pulse at position 1, second pulse at position 2, etc . . . )

Nₖ pulses (Nₖ coefficients to be transmitted): 1 combination

Alternatively, it can be seen that there are 2̂Nₖ combinations. For instance there are 2̂10=1024 combinations for 10 coefficients in a band.

In some variants of this embodiment, if it is desired to reduce complexity (for example to reduce the number of calculations to be performed by the pulse selection block 108_{M}) it might be preferred to search only through a certain sub-set or sub-sets of all possible combinations.

FIG. 5 shows in more detail a third embodiment of the pulse selection block 108_{M} of the encoder of FIG. 2. This pulse selection block 108_{M} operates iteratively in order to carry out a coefficient-by-coefficient examination and extract particular pulses for encoding. The pulse selection block 108_{M} comprises an input 502, which is fed both to a coefficient memory 504 and to an amplitude value calculation block 506. The coefficient memory 504 is coupled in sequence to various other blocks: a maximum coefficient selection block 508, a dₖ computation block 510, a comparison block 512, and (via a “no” branch), the amplitude value calculation block 506. The amplitude value calculation block 506 has two outputs—a first output 514 for an amplitude value and a second output 516 for pulses. In addition to the blocks already described, a branch leading off a “yes” branch of the comparison block 512, is coupled in turn to a counter 518, a pulse collection block 520, and a pulse memory 522 (which are concerned with collecting and storing pulses which have been identified as being for encoding), and also to a coefficient removal block 524 which is used to update the coefficient memory 504.

In operation, the pulse selection block 108_{M} receives a particular sub-band k of a set of coefficients as described above and provides the coefficients via the input 502 to the coefficient memory 504 and to the amplitude value calculation block 506. The counter 518 which increments a variable l and a dₖ memory (not shown) are set in an initialization step so that:

l=0 and dₖ⁰=0

The coefficient with the maximum absolute value is identified in the maximum coefficient selection block 508. In the dₖ computation block 510, the criterion dₖ, given by

$${d}_{k}^{l + 1} = \frac{{[ \sqrt{{ld}_{k}^{l}} + \vert x ( b ( k ) + {j}_{l} ) \vert ]}^{2}}{l + 1} \qquad ( 10 )$$

is calculated in respect a particular coefficient x(b(k)+jₗ) Equation (10) is equation (8) written in another form.

In a first iteration, dₖ¹ is calculated. Unless the coefficient x(b(k)+jₗ) is equal to zero, dₖ¹ will be greater than dₖ⁰ because dₖ⁰=0 and so at the comparison block 512 the “yes” branch is followed. As a result, the counter 518 is incremented by 1, in the pulse collection block 520 it is noted that a pulse corresponding to the coefficient is to be stored (and at this point, the operation of converting the sign and position information of the coefficients into pulses is carried out), and a pulse is then stored in the pulse memory 522. Since the coefficient has been processed, the coefficient removal block 524 updates the coefficient memory 504 in order that it may be removed from the list of coefficients to be processed.

After a plurality of iterations, for a certain coefficient being processed, the comparison dₖ^{l+1}>dₖ^{l} in the comparison block 512 will not be true and the “no” branch will be followed. In this case, the amplitude value calculation block 506 then calculates the amplitude value. Since the amplitude value calculation block 506 has received both the coefficients of the sub-band as described above and also the pulses to be encoded from the pulse memory, it is able to calculate the amplitude value by using equation 4.

This embodiment operates on the assumption that the coefficients with the greatest amplitude values contribute most to maximizing dₖ. It is on this basis that the search is simplified so that it is not automatically the case that all of the coefficients in a sub-band are encoded into pulses.

This embodiment does not test all of the possible combinations. The possible combinations which are searched are set out as follows:

zero pulse: 1 combination
one pulse: Nₖ combinations. The coefficient with the largest amplitude value is selected
two pulses: Nₖ−1 combinations (the first pulse is always the previously chosen one, Nₖ−1 possibilities left). The coefficient with the second largest amplitude value is selected.

three pulses: Nₖ−2 combinations (one pulse is added to two previously chosen ones, Nₖ−2 possibilities left). The coefficient with the third largest amplitude value is selected.

. . .

Nₖ pulses: 1 combination (the last possible pulse is added to the previously chosen one, only 1 possibility left).

The maximum number of possible combinations for which dₖ can be calculated is:

$$1 + 2 + 3 + 4 + … + {N}_{k} - 1 + {N}_{k} + 1 = 1 + ( {N}_{k}^{*} ( {N}_{k} + 1 ) ) / 2$$

$$or$$

$${\sum }_{j = 1}^{{N}_{k}} k = \frac{{N}_{k} ( {N}_{k} + 1 )}{2} .$$

In the case of Nₖ=10, there can be as many as 56 combinations.

In operation, the third embodiment occasionally in an l+1th iteration finds a local maximum of dₖ (that is dₖ^{l+1}<dₖ^{l}) which leads to a termination of the iterative search procedure before a value of dₖ can be calculated in a l+2th iteration which might actually be greater than the value of dₖ found in an lth iteration. To deal with this problem, a fourth embodiment (which is actually a variant of the third embodiment) will now be described.

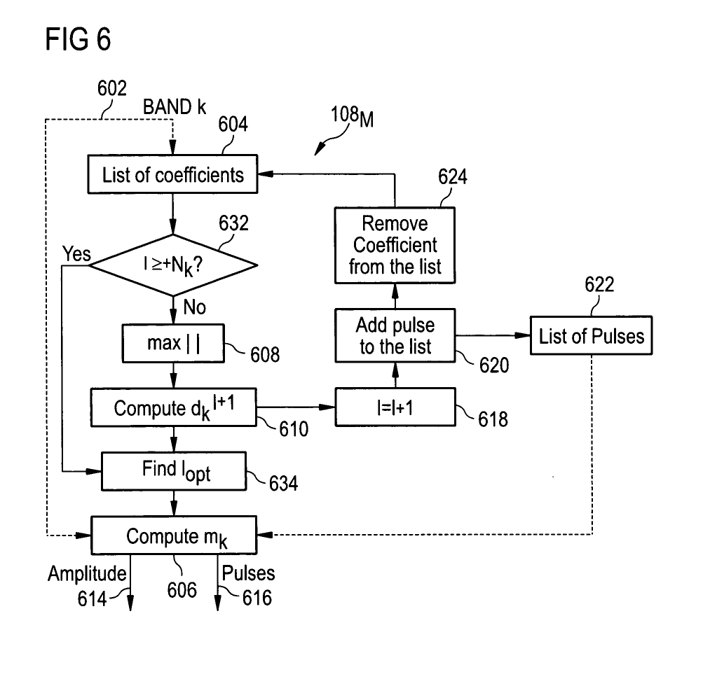

FIG. 6 shows in more detail a fourth embodiment of the pulse selection block 108_{M} of the encoder of FIG. 2. The operation of the pulse selection block 108_{M} of FIG. 6 is similar to that of FIG. 5 and for the sake of ease of explanation only the notable differences in operation will be described.

Before operation of the pulse selection block 108_{M} of FIG. 6 is described, the background to its operation in mathematical terms will be set out.

The value dₖ can be calculated as equation 8 as described in the foregoing. Let l be the number of selected coefficients and corresponding pulses among Nₖ possible positions. The search tries to maximize dₖ for each l, that is for each set of l coefficients and corresponding pulses. For l coefficients and corresponding pulses, the criterion dₖ^{l} is calculated as:

$${d}_{k}^{l} = \frac{{[ {\sum }_{j = 0}^{{N}_{k} - 1} x ( b ( k ) + j ) c ( b ( k ) + j ) ]}^{2}}{l}$$

Maximizing dₖ^{l} for a particular value of l is equivalent to maximizing the numerator

$${[ {\sum }_{j = 0}^{{N}_{k} - 1} x ( b ( k ) + j ) c ( b ( k ) + j ) ]}^{2}$$

Since the pulses have the same sign as their corresponding coefficients, then x(b(k)+j)c(b(k)+j)≧0 and therefore, the numerator can be presented as:

$${[ {\sum }_{j = 0}^{{N}_{k} - 1} \vert x ( b ( k ) + j ) c ( b ( k ) + j ) \vert ]}^{2}$$

Maximizing the square of a positive function is equivalent to maximizing the function itself. Consequently, maximizing dₖ^{l} is equivalent to maximizing

$${\sum }_{j = 0}^{{N}_{k} - 1} \vert x ( b ( k ) + j ) c ( b ( k ) + j ) \vert$$

Among the possibilities to select l pulses among Nₖ, the pulse combination that maximizes this function is necessarily the set of pulses which correspond to the l biggest absolute values of the coefficients.

In common with FIG. 5, the pulse selection block 108_{M} of FIG. 6 operates iteratively in order to carry out a coefficient-by-coefficient examination and extract particular pulses for encoding. In contrast to the pulse selection block 108_{M} of FIG. 6, rather than having a comparison block which can halt the iterative process without all of the coefficients being checked, an iterative loop (604, 632, 608, 610, 618, 620, 624) calculates a value dₖ^{l} for all values of l (that is calculates the values dₖ⁰, dₖ¹, . . . , dₖ^{l}, . . . , dₖ^{N}^{_{k−1}}, dₖ^{N}^{ₖ} by adding successively the contribution of pulses from that having the biggest absolute value to that having the smallest absolute value). When all values have been so calculated that a comparison block 632 recognizes that the iterative process is fully complete and the optimum (maximum) value of dₖ can be determined. This is carried out in an optimization block 634 which determines that corresponding of l, that is lₒₚₜ. Once lₒₚₜ has been determined, an amplitude value calculation block 606 can use it, together with pulse information from a pulse memory 622 to extract the set of lₒₚₜ pulses and to calculate mₖ.

It should be noted that in contrast to the third embodiment in which storing of pulse positions is stopped when the comparison dₖ^{l+1}>dₖ^{l} is not met, in the fourth embodiment, all of the pulse positions are stored, but only the first lₒₚₜ pulse positions are selected.

The fourth embodiment calculates a dₖ value that includes a contribution from all of the coefficients. This is different to the third embodiment in which there is a decision based on the inequality dₖ^{l+l}>dₖ^{l} which might end the sequence of iterations without including a contribution from all of the coefficients, that is, if a new dₖ value is calculated which is not greater than a previous dₖ value, the algorithm assume that the maximum has been found and no more iterations are performed.

The first embodiment is the least complex of the three embodiments, since the amplitude value mₖ is computed before the pulses are identified. The second embodiment gives consistently reliable results because the square error is minimized. However, the complexity can grow tremendously as the number of coefficients per sub-band increases. The third embodiment is much less complex than the second one, because the assumption that the coefficients with the greatest amplitude values contribute most to maximizing dₖ and prunes many combinations. Although this embodiment is sub-optimal, most of the calculations which are carried out are directed towards finding the solution of the optimization. The third embodiment achieves a good trade-off between efficiency and complexity. The fourth embodiment is an improvement on the third embodiment and incorporates a way of dealing with the problem of local maxima. It also provides a reliably good result, that is it always gives the same solution as the second embodiment.

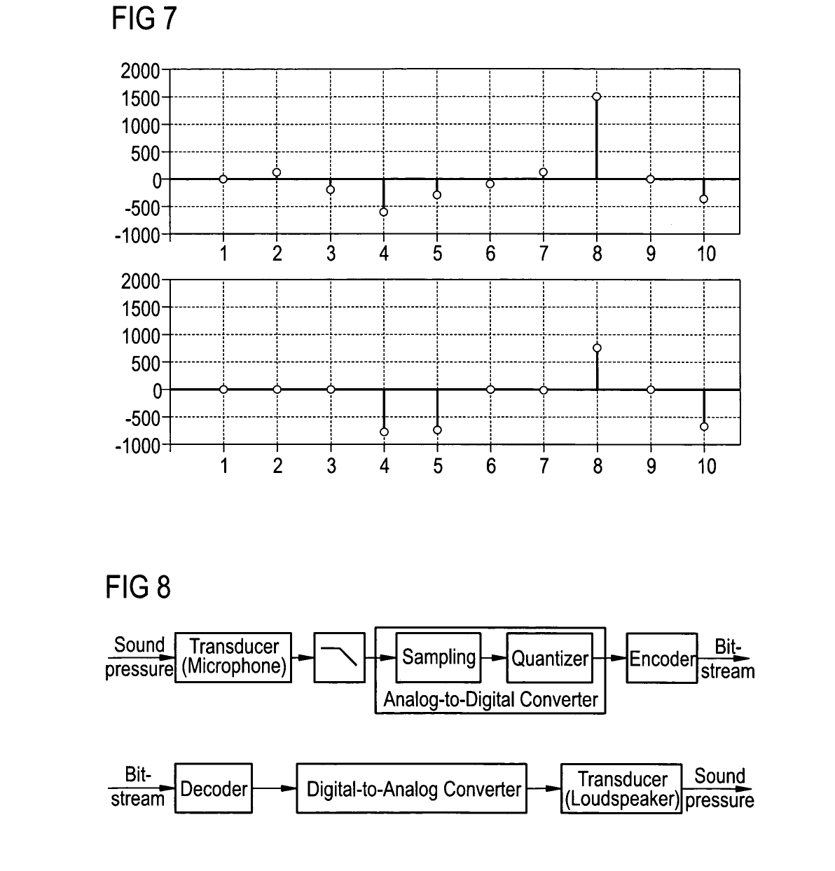

FIG. 7 shows the result of applying the proposed method to an original set of coefficients in a sub-band according to the second implementation although the principles involved apply to all of the embodiments. In the upper part of FIG. 6 is a sub-band of original coefficients received by the encoder, and in the lower part of FIG. 6 is a sub-band of reconstructed coefficients produced by the decoder. In this encoding operation, non-zero pulses will have been generated only for coefficients at positions 4, 5, 8, and 10. It can be seen that in the upper part, the coefficients have their own respective amplitude values and in the lower part the amplitude values of the reconstructed coefficients are the same, that is amplitude value \hat{m}ₖ.

The way in which quantization is carried out will now be described. For each band, the amplitude value, and the position and sign of the pulses are transmitted. The amplitude is quantized by a non uniform scalar quantizer for each band (4 bits, that is 16 different values) although other types of quantization can be employed.

The sign and position are quantized at the same time. For each position in a sub-band (there are Nₖ positions in the band k) the quantizer outputs 0 if there is no pulse. If there is a pulse, the quantizer outputs 1. Immediately following such an indication of a pulse, a bit is output for the sign, 0 if negative, 1 is positive.

Referring to FIG. 6, in quantizing the coefficients at positions 4, 5, 8 and 10, the quantizer will output bits as follow:

Position 1: 0 (no pulse)
Position 2: 0 (no pulse)
Position 3: 0 (no pulse)
Position 4: 10 (negative pulse)
Position 5: 10 (negative pulse)
Position 6: 0 (no pulse)
Position 7: 0 (no pulse)
Position 8: 11 (positive pulse)
Position 9: 0 (no pulse)
Position 10: 10 (negative pulse)

The decoder will read the bits one by one:

Position 1: 0 (no pulse, coefficient set to 0)
Position 2: 0 (no pulse, coefficient set to 0)

Position 3: 0 (no pulse, coefficient set to 0)

Position 4: 1 (there is a pulse) 0 (the pulse is negative, coefficient set to −1)
Position 5: 1 (there is a pulse) 0 (the pulse is negative, coefficient set to −1)
Position 6: 0 (no pulse, coefficient set to 0)
Position 7: 0 (no pulse, coefficient set to 0)
Position 8: 1 (there is a pulse) 1 (the pulse is negative, coefficient set to +1)
Position 9: 0 (no pulse)
Position 10: 1 (there is a pulse) 0 (the pulse is negative, coefficient set to −1)
The coefficients are multiplied by the transmitted amplitude value \hat{m}ₖ. This multiplication step can be done when the pulse positions and signs are being decoded.

The methods suggested by the inventors are simple and can be applied to many existing kind of codecs (for example G.729.1 or the proposed G.EV-VBR codec). In certain circumstances, it can be better than existing compression techniques such as Set Partitioning in Hierarchical Trees (SPIHT) and Embedded Zerotree Wavelet (EZW).

Although the method has been described in relation to speech coding, it can have applications in audio coding generally or in coding other types of signal having characteristics which would benefit from this type of coding.

There are various ways in which the method can be improved, including better quantization of the information representing the amplitude value mₖ of each sub-band (for example by using Vector Quantization, or prediction or entropy coding).

Pulse selection could be applied successively a certain number of times. This could provide a gain in quality for each application of pulse selection at the expense of increasing bit-rate. For example, there could be a succession of passes, with a first pass operating according to the embodiments described above, in a second pass, sending information which better represents coefficients that have already been quantized, and in a third pass sending pulses relating to coefficients that were set to zero but could have been better quantized. Pulse selection can be applied to the difference between the original and the quantized coefficients, and/or to the remaining coefficients that have not been transmitted.

The proposed methods are particularly suitable for use in transmission where scalable coding is applicable, for example in transmitting over links having a variable bit-rate. An example of this would be in VoIP embedded coding. There are two levels of scalability:

the coefficients in a band are quantized independently from those of other bands; and

the decoding process within a band can be stopped at any position and still yet allow for successful coding of the band (albeit perhaps to provide a rough result) because the pulse positions are encoded independently from one another. The more bits that are decoded, the more coefficients that are reconstructed.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-38. (canceled)

39. A method of encoding an audio signal comprising:
transforming the audio signal into a sequence of frames, each frame including a plurality of coefficients;
applying an optimization function to calculate respective test values corresponding to respective candidate sets of pulses representing a coded form of at least some of the coefficients;
selecting a set of pulses having a test value which meets a selectability criterion of the calculated test values; and
outputting the selected set of pulses.

40. The method according to claim 39, wherein the calculation is applied to parts of each frame and not the whole of the frame.

41. The method according to claim 39 wherein coded coefficients include the selected set of pulses multiplied by respective amplitude values.

42. The method according to claim 41 wherein the respective amplitude values for the selected set of pulses is a single amplitude value to be applied to all of the pulses.

43. The method according to claim 41 wherein the selected set of pulses is used to calculate an amplitude value for each of the frames.

44. A method according to claim 43 wherein the amplitude value calculation is further based on the coded coefficients.

45. The method according to claim 41 wherein selecting a particular pulse involves comparing the original coefficient with a coded coefficient in the form of a pulse multiplied by an amplitude value.

46. The method according to claim 39 wherein applying the optimization function includes selecting a set of pulses to represent some or all of the coefficients on a basis that the set of pulses is an approximate match to the coefficients.

47. The method according to claim 39 wherein not all of the coefficients are represented by a pulse.

48. The method according to claim 39 wherein an error function representing differences between original coefficients and coded coefficients is applied to various combinations of coefficients in order to identify a set of coefficients that provide a lowest error value.

49. The method according to claim 48 wherein the optimization function is the error function.

50. The method according to claim 49 wherein the selectability criterion identifies a minimum error result produced by the error function for a plurality of candidate sets of pulses.

51. The method according to claim 50 wherein the selected set of pulses is selected from a plurality of candidate sets of pulses used to calculate respective amplitude values for each frame or a sub-set of the frame.

52. The method according to claim 39 wherein an iterative process is used to produce a succession of test values, one of the succession of test values being identified as the test value that indicates a selected set of coefficients when the iterative process is perceived to have produced a less optimum test value than a previous test value.

53. The method according to claim 39 wherein an iterative process is used to produce a succession of test values calculated by successively adding a contribution from at least one additional coefficient to the calculation of each of the test values.

54. The method according to claim 53 wherein a contribution is provided by each of the coefficients until a contribution from all of the coefficients has been provided.

55. The method according to claim 53 wherein the set of pulses is selected that corresponds to a set of coefficients that provides a most optimum test value.

56. The method according to claim 52 wherein the iterative process carries out an examination of the coefficients to identify which of the coefficients are to be encoded as pulses.

57. The method according to claim 56 wherein the examination is done coefficient-by-coefficient.

58. The method according to claim 52 wherein pulses are identified up to a point at which the iterative process is perceived to have produced the less optimum test value than the previous test value.

59. The method according to claim 52 wherein the coefficients are examined in order of absolute value.

60. The method according to claim 59 wherein the examination proceeds from a largest absolute value through successively reducing absolute values until the iterative process is perceived to have produced the less optimum test value than the previous test value.

61. The method according to claim 52 wherein dₖ is calculated which represents an energy measure related to a difference between a correlation between original coefficients and corresponding candidate sets of pulses.

62. The method according to claim 39 wherein an amplitude value is calculated based on the selected pulses and the corresponding coefficients.

63. The method according to claim 43 wherein the amplitude value is an average of original coefficients for which corresponding pulses are to be transmitted.

64. The method according to claim 39 wherein original coefficients that are to be encoded as a pulse are identified by comparing the original coefficients with a threshold value.

65. The method according to claim 64 wherein the threshold value is based on an amplitude value.

66. The method according to claim 65 wherein the amplitude value is based on an average of absolute values of the original coefficients.

67. The method according to claim 39 wherein the audio signal is encoded for transmission over a wireless link in a mobile communications network.

68. The method according to claim 39 wherein the audio signal is encoded for transmission through a router switched network.

69. The method according to claim 39 wherein the audio signal is a speech signal.

70. The method according to claim 39 wherein the audio signal is transformed using wavelet packet transform.

71. A terminal capable of encoding an audio signal, comprising:
a transformer capable of transforming the audio signal into a sequence of frames, each frame including a plurality of coefficients;
an optimizer capable of applying an optimization function to calculate respective test values corresponding to respective candidate sets of pulses representing a coded form of at least some of the coefficients; and
a selector capable of selecting a set of pulses having a test value that meets a selectability criterion of the calculated test values.

72. The terminal according to claim 71, wherein the terminal is a mobile handset.

73. A network element capable of encoding an audio signal, comprising:
a transformer capable of transforming the audio signal into a sequence of frames, each frame including a plurality of coefficients;
an optimiser capable of applying an optimization function to calculate respective test values corresponding to respective candidate sets of pulses representing a coded form of at least some of the coefficients;
a selector capable of selecting a set of pulses having a test value that meets a selectability criterion of the calculated test values.

74. A system capable of encoding an audio signal, comprising:
a transformer capable of transforming the audio signal into a sequence of frames, each frame including a plurality of coefficients;
an optimiser capable of applying an optimization function to calculate respective test values corresponding to respective candidate sets of pulses representing a coded form of at least some of the coefficients; and
a selector capable of selecting a set of pulses having a test value which meets a selectability criterion of the calculated test values.

75. A computer-readable medium encoded with a computer program for encoding an audio signal, the program causing a computer to execute a method comprising:
transforming the audio signal into a sequence of frames, each frame including a plurality of coefficients;
applying an optimization function to calculate respective test values corresponding to respective candidate sets of pulses representing a coded form of at least some of the coefficients;
selecting a set of pulses having a test value which meets a selectability criterion of the calculated test values; and
outputting the selected set of pulses.

76. A chipset capable of encoding an audio signal, comprising:
a transformer capable of transforming the audio signal into a sequence of frames, each frame including a plurality of coefficients;
an optimizer capable of applying an optimization function to calculate respective test values corresponding to respective candidate sets of pulses representing a coded form of at least some of the coefficients;
a selector capable of selecting a set of pulses having a test value which meets a selectability criterion of the calculated test values.

77. A method of encoding an audio signal, comprising:
transforming the audio signal into a plurality of frames, each frame including a plurality of coefficients;
calculating an amplitude value from amplitude values of at least some of the coefficients;
determining pulses corresponding to the coefficients by using the calculated amplitude value as a threshold against which each of the coefficients is compared; and
outputting the amplitude value and the determined pulses.
